(19) United States
(12) Patent Application Publication
(10) Pub. No.: US 2014/0367138 A1
(43) Pub. Date: Dec. 18, 2014

(54) POWER ADAPTER

(71) Applicant: Lenovo (Singapore) Pte. Ltd., Singapore (SG)

(72) Inventors: Cyan Godfrey, Chapel Hill, NC (US); John David Swansey, Durham, NC (US)

(21) Appl. No.: 13/920,370

(22) Filed: Jun. 18, 2013

(51) Int. Cl. H01B 7/06

(52) U.S. Cl. CPC H01B 7/06
USPC 174/69

(57) ABSTRACT

A cable holder unit can include an equipment power cable that includes an equipment plug end, a cable reel for storage of the equipment power cable, an electrical connector electrically coupled to the equipment power cable, and a coupling mechanism. Such a cable holder unit may optionally couple to a DC unit or an AC unit. Various other apparatuses, systems, methods, etc., are also disclosed.

### TECHNICAL FIELD

Subject matter disclosed herein generally relates to power adapters for electrically powered equipment.

### BACKGROUND

Electrically powered equipment may be used in environments with differing power sources, differing outlets, etc. Electrically powered equipment may be portable and, for example, transported to and used in environments with somewhat uniform power sources, outlets, etc. and/or in environments with differing power sources, differing outlets, etc. Such scenarios present challenges for manufacturers of electrically powered equipment, especially as to what type of power cable, power adapter, etc. to provide with such equipment. Various technologies and techniques described herein pertain to power adapters.

### SUMMARY

A cable holder unit can include an equipment power cable that includes an equipment plug end, a cable reel for storage of the equipment power cable, an electrical connector electrically coupled to the equipment power cable, and a coupling mechanism. Such a cable holder unit may optionally couple to a DC unit or an AC unit. Various other apparatuses, systems, methods, etc., are also disclosed.

### BRIEF DESCRIPTION OF THE DRAWINGS

Features and advantages of the described implementations can be more readily understood by reference to the following description taken in conjunction with examples of the accompanying drawings.

FIG. 1 is a diagram of examples of power adapter systems;

FIG. 2 is a diagram of examples of power adapter systems;

FIG. 3 is a diagram of examples of power adapter systems;

FIG. 4 is a diagram of examples of two power adapter systems in transition orientations;

FIG. 5 is a diagram of an example of a system for DC power;

FIG. 6 is a diagram of an example of a system for DC power;

FIG. 7 is a diagram of examples of components associated with DC power;

FIG. 8 is a diagram of an example of a unit for AC power;

FIG. 9 is a diagram of examples of components associated with AC power;

FIG. 10 is a diagram of examples of components for a cable holder unit;

FIG. 11 is a diagram of an example of a system being held in a hand; and

FIG. 12 is a diagram of an example of a system that includes one or more processors.

### DETAILED DESCRIPTION

The following description includes the best mode presently contemplated for practicing the described implementations. This description is not to be taken in a limiting sense, but rather is made merely for the purpose of describing general principles of various implementations. The scope of invention should be ascertained with reference to issued claims.

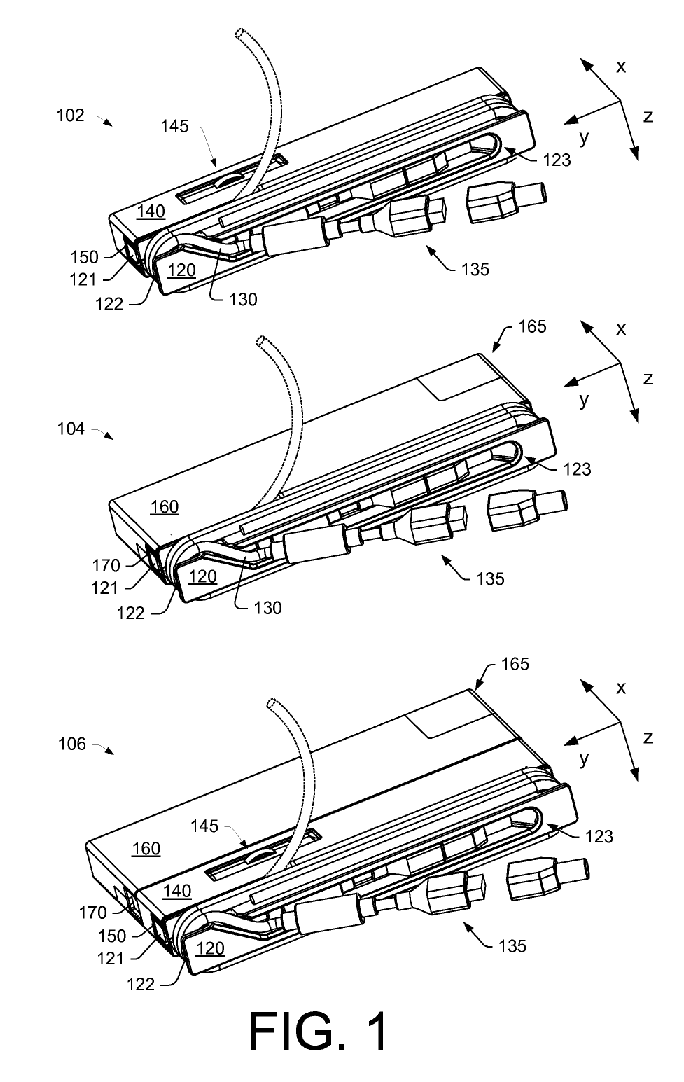

FIG. 1 shows an example of a system 102, an example of a system 104 and an example of a system 106. Each of the systems 102, 104 and 106 is shown along with a Cartesian coordinate system that includes x, y and z axes. Various features of the systems 102, 104 and 106 may be described with respect to the Cartesian coordinate system. For example, length (e.g., along a y-axis), width (e.g., along an x-axis), depth (e.g., along a z-axis), aspect ratios, relationships between features, etc. may be described with respect to the Cartesian coordinate system.

In the example of FIG. 1, the systems 102, 104 and 106 each include a cable holder unit 120 that includes an equipment power cable 130 that includes a fixed end and an equipment plug end 135, a cable reel 122 for storage of the equipment power cable 130, a plug holder 123 to secure the equipment plug end 135 of the equipment power cable 130, an electrical connector 121 electrically coupled to the equipment power cable 130, and a coupling mechanism. As an example, a cable may include conductors (e.g., wires) for conducting electricity (e.g., flow of electrical charges) and may include one or more layers of insulating material and optionally one or more layers of other material. As an example, a conductor may be or include a material such as metal, alloy, etc. As an example, a conductor may be solid, braided, etc.

In FIG. 1, the system 102 includes a DC unit 140 that includes a DC power cable 144 that includes a DC plug end 145 and a fixed end 149, a DC electrical connector 150 electrically coupled to the DC power cable 144, and a coupling mechanism that couples to the coupling mechanism of the cable holder unit 120. FIG. 1 shows the system 102 in a coupled orientation of the cable holder unit 120 and the DC unit 140 where the electrical connector 121 of the cable holder unit 120 connects to the electrical connector 150 of the DC unit 140 to electrically connect the DC plug end 145 and the equipment plug end 135 of the equipment power cable 130.

In FIG. 1, the system 104 includes an AC unit 160 that includes an AC power plug 165, an AC electrical connector 150 electrically coupled to the AC power plug 165, and a coupling mechanism that couples to the coupling mechanism of the cable holder unit 120. FIG. 1 shows the assembly 104 in a coupled orientation of the cable holder unit 120 and the AC unit 160 where the electrical connector 121 of the cable holder unit 120 connects to the electrical connector 170 of the AC unit 160 to electrically connect the AC power plug 165 and the equipment plug end 135 of the equipment power cable 130.

In FIG. 1, the system 104 includes the cable holder unit 120, the DC unit 140 and the AC unit 160. As shown, the DC unit 140 includes a first coupling mechanism that couples to the coupling mechanism of the cable holder unit 120 and a second coupling mechanism and the AC unit 160 includes a coupling mechanism that couples to the coupling mechanism of the cable holder unit 120 or that couples to the second coupling mechanism of the DC unit 140.

As an example, the cable holder unit 120 can include an inner surface of the cable reel 122 that defines the plug holder 123. For example, the inner surface may define a recess that can hold the equipment plug end 135. As an example, the cable holder unit 120 may include an elastomer, for example, deformable to accommodate the equipment plug end 135 and to apply a biasing force against the equipment plug end 135 to secure the equipment plug end 135 with respect to the cable holder unit 120. As an example, the elastomer may provide a comfortable surface for touch, for example, to avoid damage to finger nails, etc.

As an example, an elastomer may be a polymer with viscoelasticity and, for example, a relatively low Young's modulus (e.g., modulus of elasticity or elastic modulus) and high failure strain compared with other materials (e.g., rigid materials). As an example, an elastomer may be a rubber, which may be a vulcanisate. As an example, an elastomer may be formed of monomers that link (e.g., where the monomers may include one or more of carbon, hydrogen, oxygen, silicon, etc.). As an example, an elastomer may be made of amorphous state polymers existing above their glass transition temperature, so that considerable segmental motion is possible. As an example, at ambient temperatures, an elastomer may be relatively soft and deformable. As an example, a rubber may have an elastic modulus of about 0.01 to about 0.1 GPa; whereas, a material such as acrylonitrile butadiene styrene (ABS) may have an elastic modulus of about 2.3 GPa (e.g., a harder material than the rubber). As an example, a cable holder unit may be an assembly of components, for example, that includes a harder component and a more elastic component (e.g., for securing a plug end of a cable).

In FIG. 1, a dotted line indicates a deployed orientation of the equipment power cable 130 with respect to the cable holder unit 120. For example, the equipment power cable 130 extends away from the cable holder unit 120 from a side that is opposite a plug end side (e.g., a prong side) of the AC unit 160 (e.g., for a coupled orientation of the cable holder unit 120 and the AC unit 160). In such an example, prongs of an AC unit may be received by an outlet in a planar surface without interference from a deployed equipment power cable.

As an example, the coupling mechanism of the cable holder unit 120 and the coupling mechanism of the DC unit 140 may include at least one rail. As an example, the coupling mechanism of the cable holder unit 120 and the coupling mechanism of the AC unit 160 may include at least one rail.

As an example, the coupling mechanism and the electrical connector 121 of the cable holder unit 120 may be positioned on an edge of the cable holder unit 120. As an example, the coupling mechanism and the electrical connector 150 of the DC unit 140 may be positioned on an edge of the DC unit 140 where, in the coupled orientation of the cable holder unit 120 and the DC unit 140, the cable holder unit 120 and the DC unit 140 are joined along respective edges to form an electrical connection between the electrical connector 121 and the electrical connector 150. As an example, the coupling mechanism and the electrical connector 121 of the cable holder unit 120 may be positioned on an edge of the cable holder unit 120 where the coupling mechanism and the electrical connector 170 of the AC unit 160 are positioned on an edge of the AC unit 160 and where, in the coupled orientation of the cable holder unit 120 and the AC unit 160, the cable holder unit 120 and the AC unit 160 are joined along respective edges to form an electrical connection between the electrical connector 121 and the electrical connector 170.

As an example, the electrical connector 121 of the cable holder unit 120 may include a prong, the electrical connector 150 of the DC unit 140 may include a socket (e.g., configured for receipt of the prong) and the electrical connector 170 of the AC unit 160 may include a socket (e.g., configured for receipt of the prong). In such a manner, the cable holder unit 120 may couple to the DC unit 140 or the AC unit 160.

As an example, the DC plug end 145 of the DC unit 140 may include a configurable assembly that includes multiple DC plugs. As an example, the AC power plug end 165 of the AC unit 160 may be provided as a configurable assembly that includes multiple AC plugs (e.g., for different types of AC outlets such as found in the US, Europe, Asia, South America, Australia, etc.). As an example, the DC unit 140 can include a recess for storage of the DC plug end 145. As an example, the AC unit 160 may include a planar surface and the AC power plug 165 may include retractable prongs that, in an unretracted orientation, extend outwardly from the planar surface (e.g., for receipt by a power outlet, a socket of a power cable, etc.). As an example, the plug end 135 of the equipment power cable 130 may be fitted with a plug adapter.

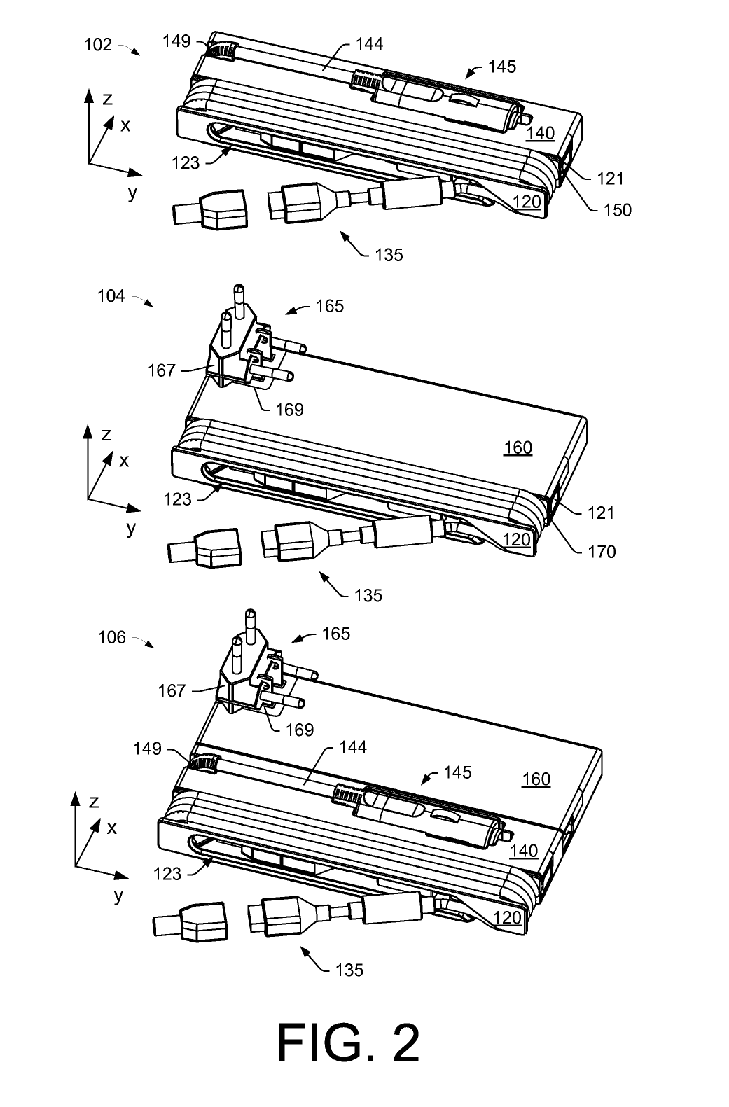

FIG. 2 shows additional views of the systems 102, 104 and 106 along with respective Cartesian coordinate systems include x, y and z axes. Various features of the systems 102, 104 and 106 may be described with respect to the Cartesian coordinate system. For example, length (e.g., along a y-axis), width (e.g., along an x-axis), depth (e.g., along a z-axis), aspect ratios, relationships between features, etc. may be described with respect to the Cartesian coordinate system.

In FIG. 2, the DC power plug 145 is shown as being operatively coupled to a cable 144 with a fixed end 149. As shown, the DC power plug 145 can include a cylindrical shape, for example, with conductors along a side and an end. As an example, the DC power plug 145 may be a mating plug for a socket defined in the ANSI/SAE J563 specification. For example, for approximately 12 volt systems, according to the ANSI/SAE J563 specification, the “contact point”, which is the center part of the plug when viewed end-on, carries a positive voltage, whereas the “can” part, which is the outer part of the connector, carries a negative voltage (e.g., a “ground” connection). As an example, vehicles may include a socket that complies with the UL2089 standard (e.g., for a plug that can mate with a cigarette receptacle).

In FIG. 2, the AC power plug 165 is shown approximately as an assembly, for example, to illustrate various plug options. As an example, a detachable multi-plug component 167 (e.g., with multiple sets of prongs) may be connected to another plug component 169, for example, that includes retractable prongs. As an example, a detachable plug component with a single set of prongs may be provided that connects to the plug component 169.

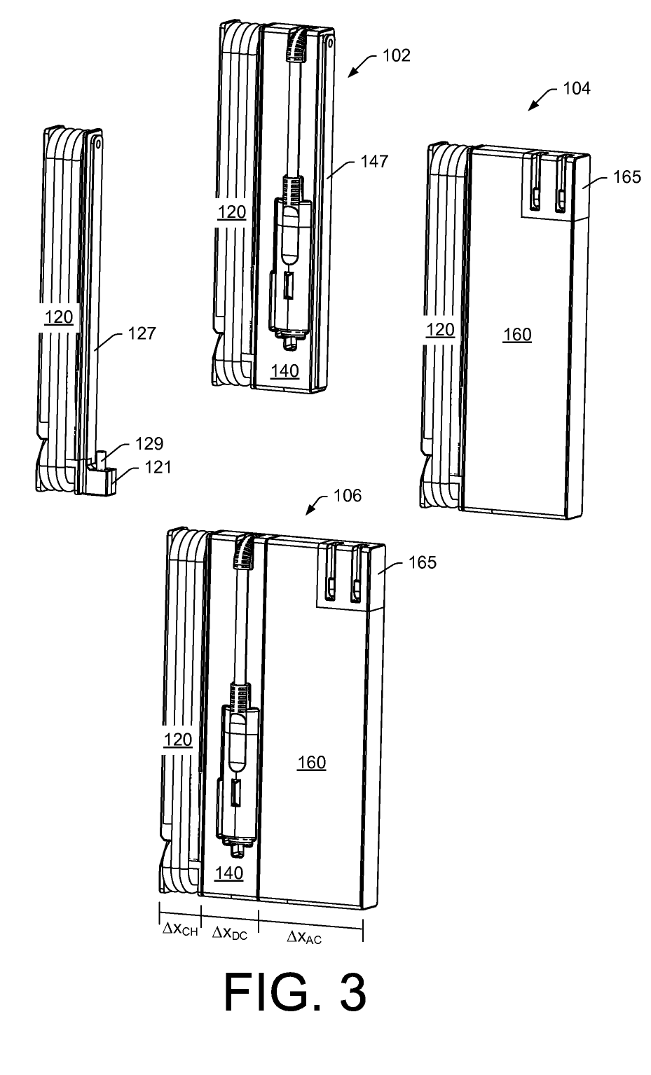

FIG. 3 shows perspective views of the systems 102, 104 and 106 along with a perspective view of the cable holder unit 120. In FIG. 3, the AC power plug 165 is shown as including two retracted prongs. In FIG. 3, the cable holder unit 120 is shown with the connector 121 as including a prong 129 as well as a rail 127 along an edge, for example, as a coupling mechanism for coupling to either the DC unit 140 or the AC unit 160. FIG. 3 also shows the DC unit 140 as including a rail 147, for example, to coupling the DC unit 140 and the AC unit 160. As an example, each of the units 120, 140 and 160 may include a width, as shown with respect to the system 106 (see, e.g., ΔX_{CH}, ΔX_{DC}, ΔX_{AC}).

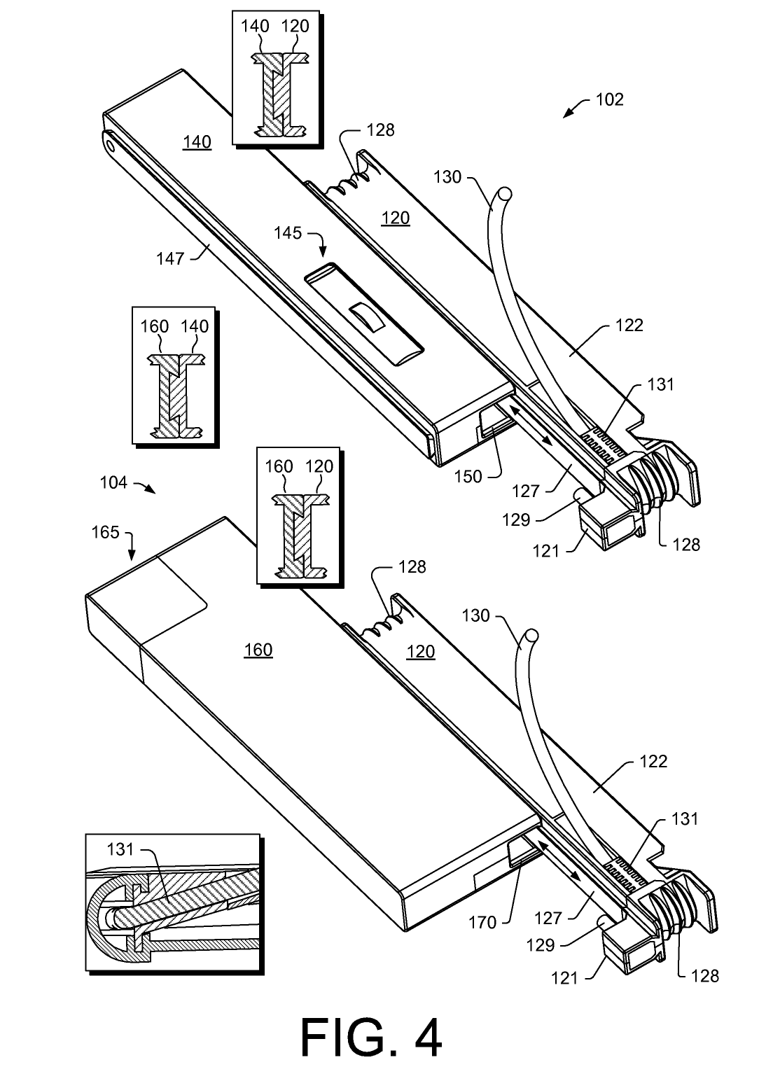

FIG. 4 shows perspective views of examples of the systems 102 and 104 in transition to or from their respective coupled orientations (e.g., via translation along a long axis) and several cross-sectional views. As shown, coupling mechanisms may include rails along an edge of a unit, for example, where coupling may or may not include connecting electrical connectors. For example, where the AC unit 160 is coupled to the DC unit 140, the coupling mechanism acts to join the units 140 and 160 but not electrically connector their respective electrical connectors 150 and 170 as these are provided for electrical connection to the electrical connector 121 of the cable holder unit 120. Three cross-sectional views illustrate how rails may cooperate for coupling respective units. As an example, a first unit may include a rail along an edge while a second unit may include a pair of rails along an edge, the pair configured to receive the rail of the first unit (e.g., spaced apart rails) for coupling the first unit and the second unit.

FIG. 4 also shows the equipment power cable 130 in a deployed orientation where the cable reel 122 of the cable holder unit 120 is shown as including ridges 128, for example, at one or both ends of the cable reel 122. Such ridges may facilitate winding of the equipment power cable 130 onto the cable reel 122.

In the examples of FIG. 4, a fixed end 131 of the equipment power cable 130 is shown, which may be, for example, proximate to the electrical connector 121 (e.g., to reduce length of wire, etc.). In FIG. 4, one of the cross-sectional views shows the fixed end 131 of the equipment power cable 130 with a flexible fixture that may allow for angling the cable 130 away from the cable holder unit 120 in a deployed orientation.

As an example, a fixed end or fixable end may allow for rotation of a cable, for example, about an axel, half-axels, etc. where electrical connection may be provided via contacts (e.g., via the axel, half-axels, etc.).

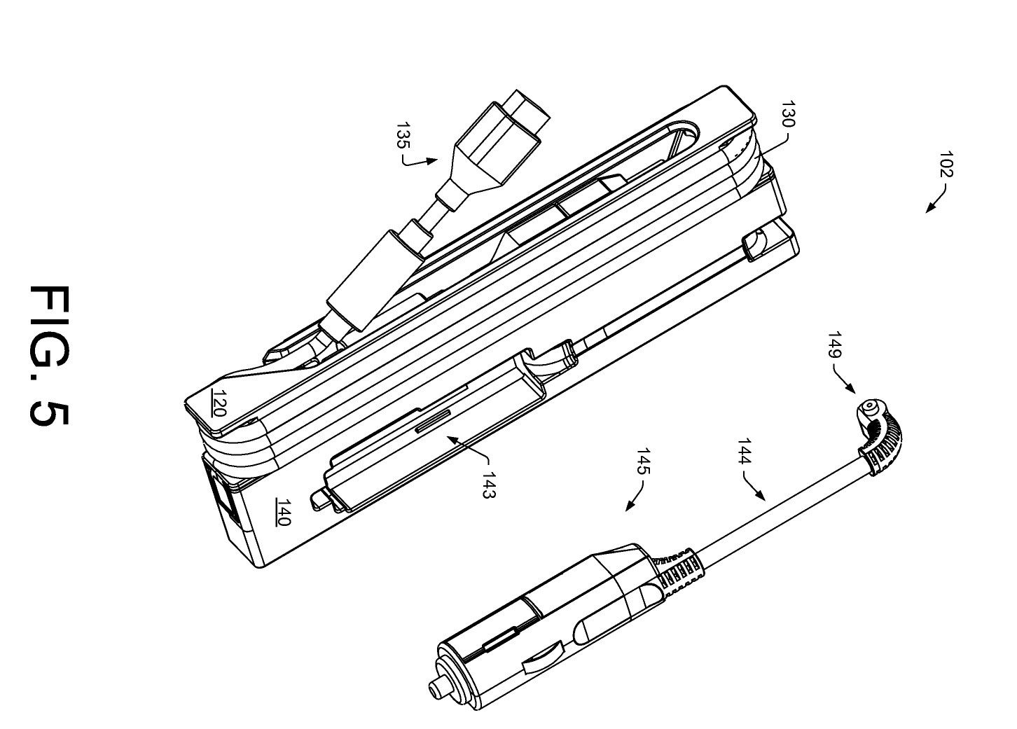

FIG. 5 shows a partially exploded, perspective view of the DC unit 140 where the DC plug end 145 is removed from its recess 143. As an example, the DC plug end 145 may include the cable portion 144 with a fixable end 149, for example, with a connector, an axel, a hinge, etc. to thereby become a fixed end with respect to the DC unit 140. As an example, the DC plug end 145 may rotate into and out of its recess 143. As shown in FIG. 5, the DC plug end 145 may have a can configuration, where an axial length of the can is aligned with a long axis of the DC unit 140.

As an example, the fixable end 149 may allow for rotation of the cable portion, for example, about an axel, half-axels, etc. where electrical connection may be provided via contacts (e.g., via the axel, half-axels, etc.).

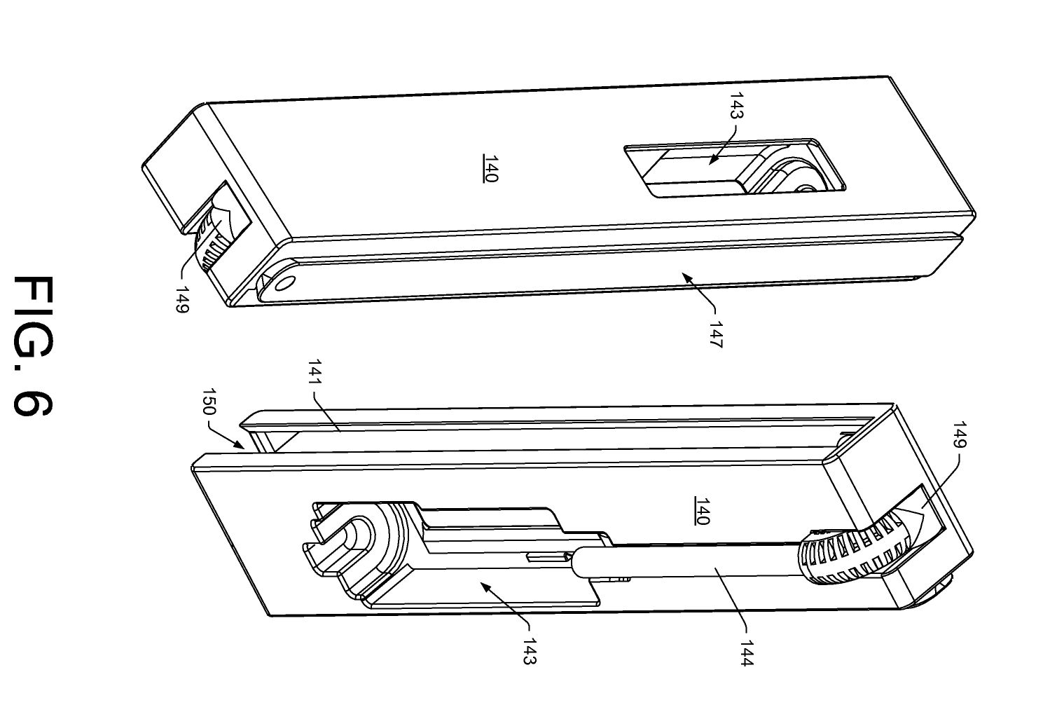

FIG. 6 shows two perspective views of the DC unit 140 without the DC plug end 145 and with the cable 144. In FIG. 6, rails 141 are shown as extending along an edge of the DC unit 140 where the electrical connector 150 is disposed at that same edge (e.g., at or near an end of the edge).

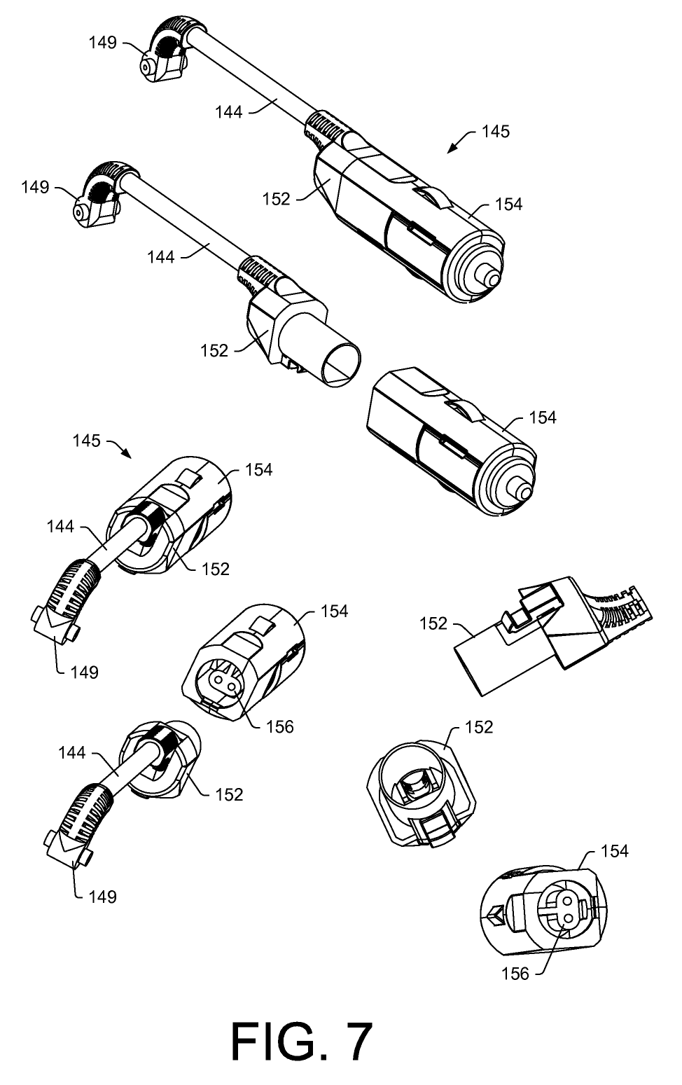

FIG. 7 shows various perspective views of the DC plug 145 as an assembly that includes a base portion 152 and a can portion 154 that couples to the base portion 152. As an example, the can portion 154 may include a socket 156 that cooperates with prongs of the base portion 152. As an example, the prongs of the base portion may be configured for receipt by a DC outlet. For example, the base portion 152 may be a plug for an EmPower® outlet (marketed by Astronics, Inc., Kirkland, Wash.), for example, a type of DC power connector type found on various aircraft. As an example, a unit may include a USB connector, for example, to couple to a DC source of power and to electrically couple that source to an equipment power cable. For example, a male USB connector may fit into the can portion 154 (e.g., configured to mate with a cigarette receptacle) where removal of the can portion 154 allows for connecting the male USB connector to a female USB connector. As an example, a DC unit may be configured to couple to and/or provide DC power in a range from about 1 V to about 24 V. As an example, a DC unit may include circuitry to convert from one DC voltage to another DC voltage. For example, a can portion, which may be detachable, may include circuitry for DC-to-DC conversion (e.g., from about 12 V to about 5 V).

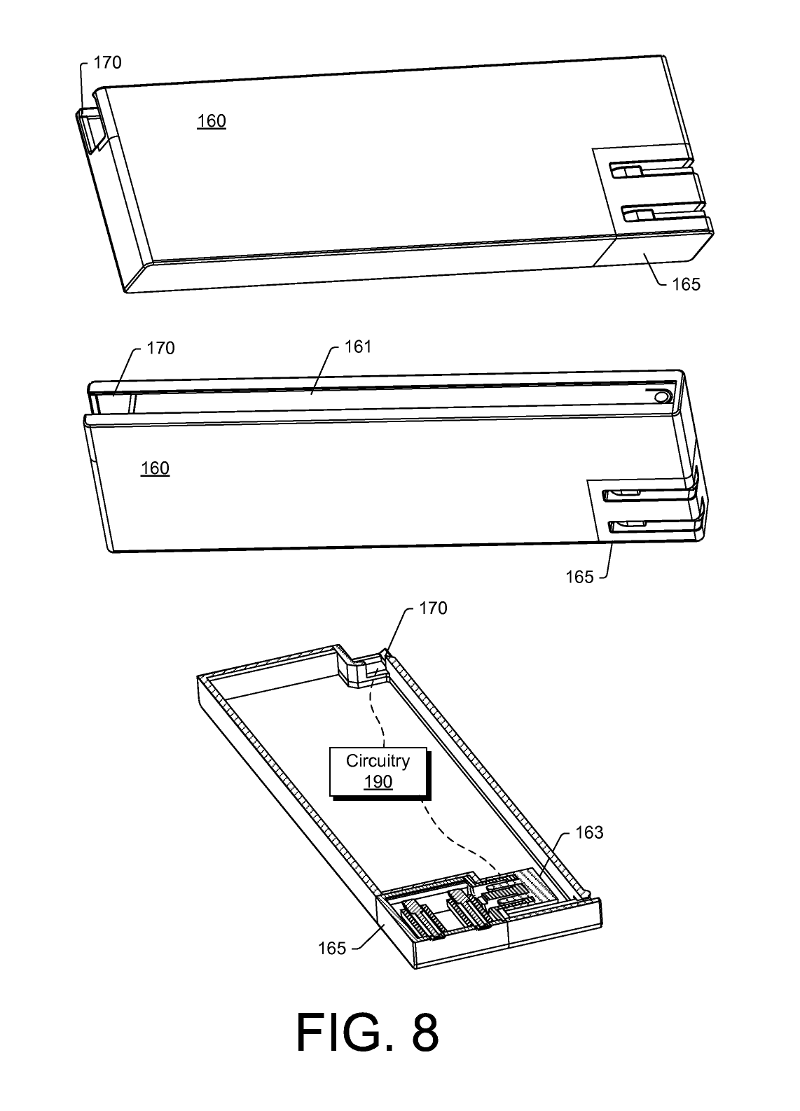

FIG. 8 shows two perspective views of the AC unit 160 and a cross-sectional view of the AC unit 160. In FIG. 8, the AC unit 160 is shown as including rails 161 along an edge as a coupling mechanism to couple the AC unit 160 to the cable holder unit 120 or the DC unit 140. In the example of FIG. 8, the AC unit 160 may include circuitry 190, for example, to covert AC power from an outlet to a power type suitable for electrically powered equipment. For example, the circuitry 190 may include circuits for converting 120 V, 220 V, etc. power to a power type suitable for receipt by battery charging circuitry to charge a battery that can power equipment. For example, consider a battery that includes one or more lithium-based electrochemical cells and circuitry for charging such one or more cells. As an example, a notebook computer may include one or more lithium-based electrochemical cells, for example, as rechargeable batteries.

In the cross-sectional view of FIG. 8, the AC unit 160 is shown as including a connector 163 for connection to the AC power plug 165, for example, to allow for electrical connections between prongs of the AC power plug 165 and the circuitry 190 of the AC unit 160. As an example, the circuitry 190 can connect to the electrical connector 170 and to the connector 163, as indicated by dashed lines. As an example, the circuitry 190 may be disposed within a cavity within the AC unit 160. As an example, the electrical connector 170 may be configured to receipt the prong 129 of the electrical connector 121 of the cable holder unit 120.

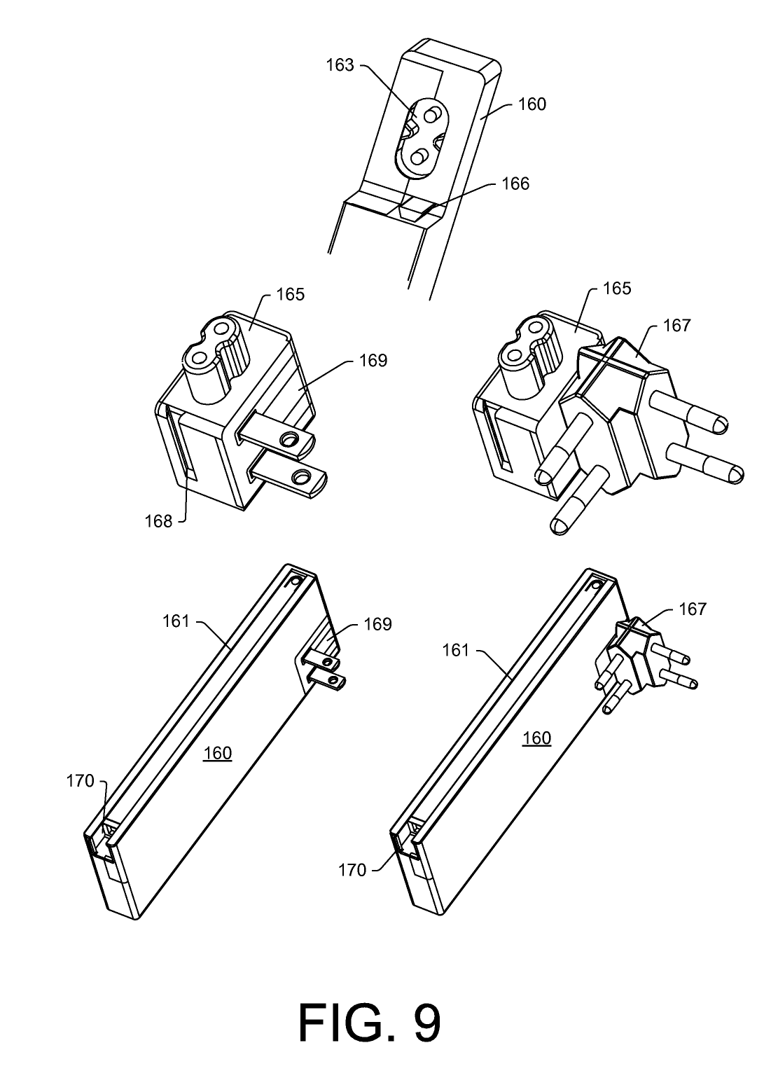

FIG. 9 shows various perspective views of components, features, etc. associated with the AC unit 160. For example, FIG. 9 shows the connector 163 of the AC unit 160 along with a rail 166 where the AC power plug 165 includes corresponding cooperating features (see, e.g., rails 168 that define a groove that can receive the rail 166). As shown, the AC power plug 165 can include a retractable prong portion 169 that may be configured to couple with an adapter portion 167, which may include one or more sets of prongs (e.g., for one or more types of AC power outlets).

In FIG. 9, the rails 161 may form a groove for receipt of a rail of the DC unit 140 or a rail of the cable holder unit 120. As an example, rails that form a groove and rails for receipt in such a groove may be oriented as being on one unit or another. For example, the cable holder unit 120 may include rails that define a groove for receipt of rails (or a rail) of the DC unit 140 or the AC unit 160. As an example, the cable holder unit 120 may include a rail or rails for receipt by a groove formed by rails of the DC unit 140 or the AC unit 160.

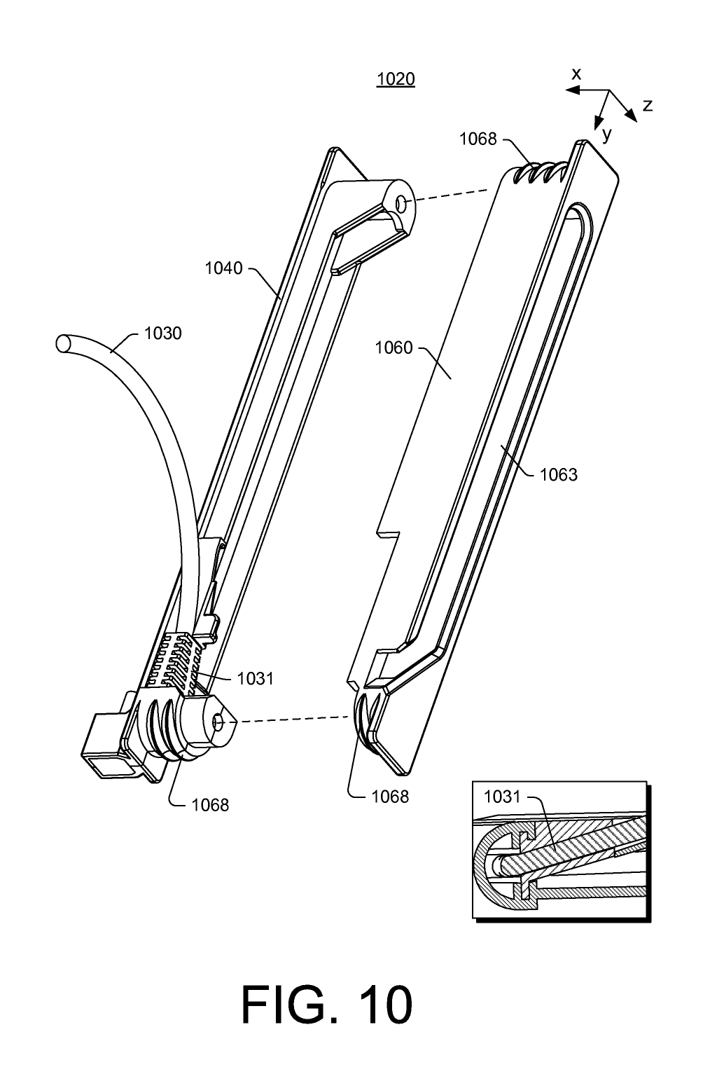

FIG. 10 shows an example of a cable holder unit 1020 that includes a component 1040 and a component 1060 as well as a portion of an equipment power cable 1030. As an example, the components 1040 and 1060 may be made from different types of materials. For example, the component 1040 may be made from a rigid polymeric material while the component 1060 may be made from an elastomeric polymeric material (e.g., materials with different elastic moduli). As shown in the example of FIG. 10, the component 1060 forms a portion of a cable reel and may include ridges 1068. As an example, the component 1060 may include a holder portion 1063 formed by an inner surface of the component 1060, for example, that defines a recess. As an example, the component 1060 may be deformable to receive an equipment power plug end of a power cable and to secure the equipment power plug (e.g., for storage, transport, etc.).

FIG. 10 also shows a cross-sectional view of a fixed end 1031 of the equipment power cable 1030. For example, a flexible fixture may be fit on the cable 1030 and slotted into the component 1040 where the flexible fixture allows for angling the cable 1030 away from the cable holder unit 1020 in a deployed orientation.

As an example, the component 1040 and 1060 may be connected via a snap mechanism, a screw mechanism or other mechanism. When connected, the components 1040 and 1060 may form the cable holder unit 1020 for holding the cable 1030, a portion of which is illustrated (e.g., in a deployed state).

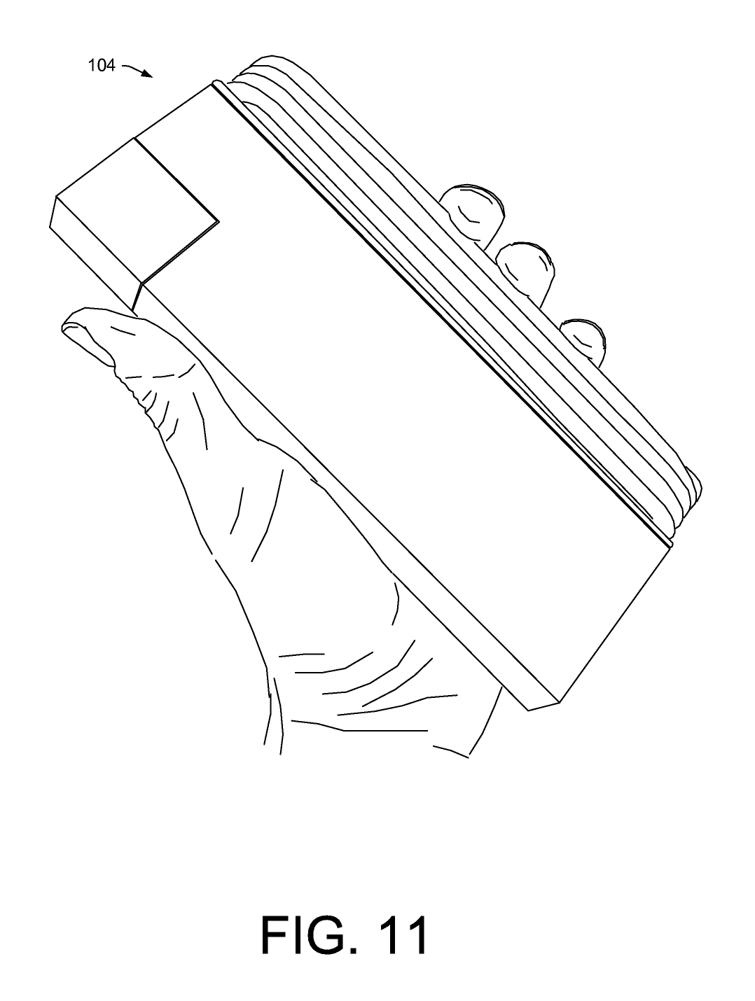

FIG. 11 shows an approximate perspective view of the system 104 as being held in a hand, for example, to illustrate approximate size, dimensions, etc. of an example of the system 104 (e.g., noting that an approximation of an example of the system 102 or an example of the system 106 may be appreciated from the illustration of FIG. 11, for example, in combination with the illustrations of FIG. 1).

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions. Such circuitry may optionally rely on one or more computer-readable media that includes computer-executable instructions. As an example, circuitry may be configured to convert, filter, etc. power (e.g., consider the circuitry 190 of FIG. 9, etc.). As described herein, a computer-readable medium may be a storage device (e.g., a memory card, a storage disk, etc.) and referred to as a computer-readable storage medium.

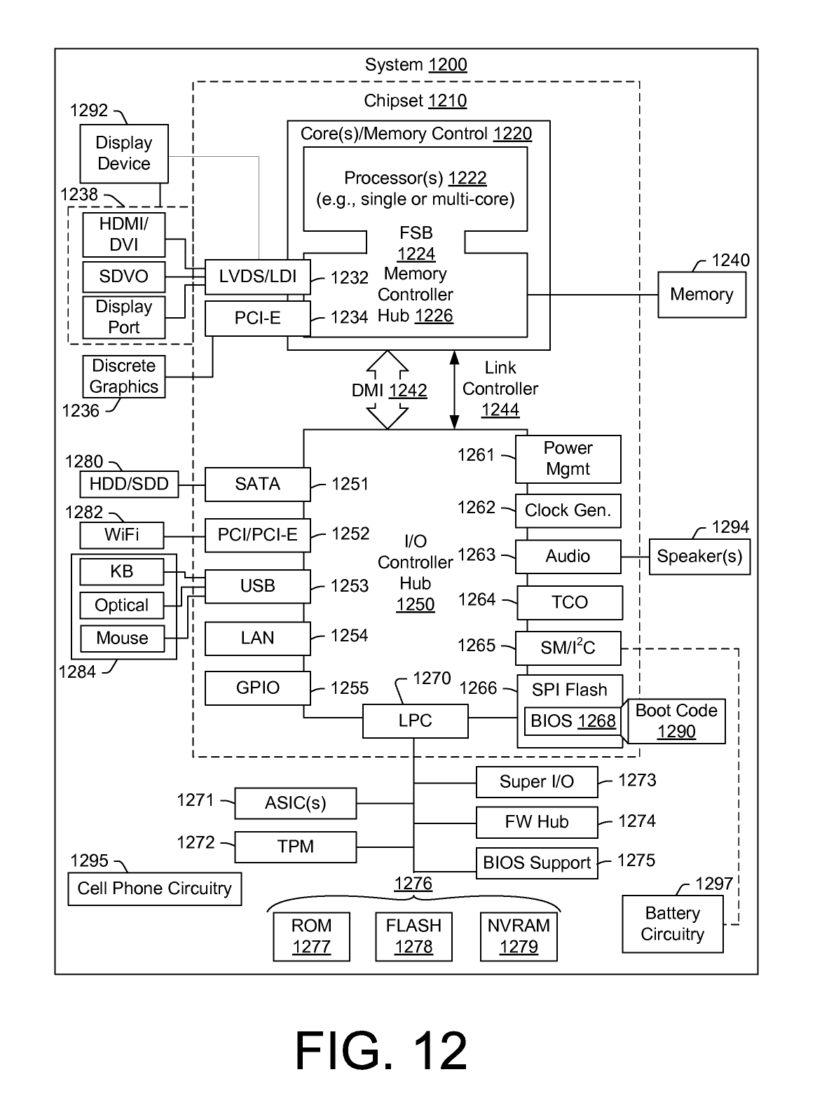

FIG. 12 depicts a block diagram of an illustrative computer system 1200. The system 1200 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C. As an example, a system such as one of the systems of the various figures may be configured to operate as a power adapter for an information handling system that may include at least some of the features of the system 1200.

As shown in FIG. 12, the system 1200 includes a so-called chipset 1210. A chipset refers to a group of integrated circuits, or chips, that are designed (e.g., configured) to work together. Chipsets are usually marketed as a single product (e.g., consider chipsets marketed under the brands INTEL®, AMD®, etc.).

In the example of FIG. 12, the chipset 1210 has a particular architecture, which may vary to some extent depending on brand or manufacturer. The architecture of the chipset 1210 includes a core and memory control group 1220 and an I/O controller hub 1250 that exchange information (e.g., data, signals, commands, etc.) via, for example, a direct management interface or direct media interface (DMI) 1242 or a link controller 1244. In the example of FIG. 12, the DMI 1242 is a chip-to-chip interface (sometimes referred to as being a link between a “northbridge” and a “southbridge”).

The core and memory control group 1220 include one or more processors 1222 (e.g., single core or multi-core) and a memory controller hub 1226 that exchange information via a front side bus (FSB) 1224. As described herein, various components of the core and memory control group 1220 may be integrated onto a single processor die, for example, to make a chip that supplants the conventional “northbridge” style architecture.

The memory controller hub 1226 interfaces with memory 1240. For example, the memory controller hub 1226 may provide support for DDR SDRAM memory (e.g., DDR, DDR2, DDR3, etc.). In general, the memory 1240 is a type of random-access memory (RAM). It is often referred to as “system memory”.

The memory controller hub 1226 further includes a low-voltage differential signaling interface (LVDS) 1232. The LVDS 1232 may be a so-called LVDS Display Interface (LDI) for support of a display device 1292 (e.g., a CRT, a flat panel, a projector, etc.). A block 1238 includes some examples of technologies that may be supported via the LVDS interface 1232 (e.g., serial digital video, HDMI/DVI, display port). The memory controller hub 1226 also includes one or more PCI-express interfaces (PCI-E) 1234, for example, for support of discrete graphics 1236. Discrete graphics using a PCI-E interface has become an alternative approach to an accelerated graphics port (AGP). For example, the memory controller hub 1226 may include a 16-lane (x16) PCI-E port for an external PCI-E-based graphics card. A system may include AGP or PCI-E for support of graphics. As described herein, a display may be a sensor display (e.g., configured for receipt of input using a stylus, a finger, etc.). As described herein, a sensor display may rely on resistive sensing, optical sensing, or other type of sensing.

The I/O hub controller 1250 includes a variety of interfaces. The example of FIG. 12 includes a SATA interface 1251, one or more PCI-E interfaces 1252 (optionally one or more legacy PCI interfaces), one or more USB interfaces 1253, a LAN interface 1254 (more generally a network interface), a general purpose I/O interface (GPIO) 1255, a low-pin count (LPC) interface 1270, a power management interface 1261, a clock generator interface 1262, an audio interface 1263 (e.g., for speakers 1294), a total cost of operation (TCO) interface 1264, a system management bus interface (e.g., a multi-master serial computer bus interface) 1265, and a serial peripheral flash memory/controller interface (SPI Flash) 1266, which, in the example of FIG. 12, includes BIOS 1268 and boot code 1290. With respect to network connections, the I/O hub controller 1250 may include integrated gigabit Ethernet controller lines multiplexed with a PCI-E interface port. Other network features may operate independent of a PCI-E interface.

The interfaces of the I/O hub controller 1250 provide for communication with various devices, networks, etc. For example, the SATA interface 1251 provides for reading, writing or reading and writing information on one or more drives 1280 such as HDDs, SDDs or a combination thereof. The I/O hub controller 1250 may also include an advanced host controller interface (AHCI) to support one or more drives 1280. The PCI-E interface 1252 allows for wireless connections 1282 to devices, networks, etc. The USB interface 1253 provides for input devices 1284 such as keyboards (KB), one or more optical sensors, mice and various other devices (e.g., microphones, cameras, phones, storage, media players, etc.). On or more other types of sensors may optionally rely on the USB interface 1253 or another interface (e.g., I²C, etc.). As to microphones, the system 1200 of FIG. 12 may include hardware (e.g., audio card) appropriately configured for receipt of sound (e.g., user voice, ambient sound, etc.).

In the example of FIG. 12, the LPC interface 1270 provides for use of one or more ASICs 1271, a trusted platform module (TPM) 1272, a super I/O 1273, a firmware hub 1274, BIOS support 1275 as well as various types of memory 1276 such as ROM 1277, Flash 1278, and non-volatile RAM (NVRAM) 1279. With respect to the TPM 1272, this module may be in the form of a chip that can be used to authenticate software and hardware devices. For example, a TPM may be capable of performing platform authentication and may be used to verify that a system seeking access is the expected system.

The system 1200, upon power on, may be configured to execute boot code 1290 for the BIOS 1268, as stored within the SPI Flash 1266, and thereafter processes data under the control of one or more operating systems and application software (e.g., stored in system memory 1240). An operating system may be stored in any of a variety of locations and accessed, for example, according to instructions of the BIOS 1268. Again, as described herein, a satellite, a base, a server or other machine may include fewer or more features than shown in the system 1200 of FIG. 12. Further, the system 1200 of FIG. 12 is shown as optionally include cell phone circuitry 1295, which may include GSM, CDMA, etc., types of circuitry configured for coordinated operation with one or more of the other features of the system 1200 (see, e.g., the devices 120, 120, etc.). Also shown in FIG. 12 is battery circuitry 1297, which may provide one or more battery, power, etc., associated features (e.g., optionally to instruct one or more other components of the system 1200). As an example, the battery circuitry 1297 may electrically couple with a system such as the system 102, the system 104, etc. As mentioned, a SMBus may be operable via a LPC (see, e.g., the LPC interface 1270), via an I²C interface (see, e.g., the SM/I²C interface 1265), etc.

### CONCLUSION

Although examples of methods, devices, systems, etc., have been described in language specific to structural features and/or methodological acts, it is to be understood that the subject matter defined in the appended claims is not necessarily limited to the specific features or acts described. Rather, the specific features and acts are disclosed as examples of forms of implementing the claimed methods, devices, systems, etc.

What is claimed is:

1. A system comprising:
a cable holder unit that comprises
an equipment power cable that comprises a fixed end and an equipment plug end,
a cable reel for storage of the equipment power cable,
a plug holder to secure the equipment plug end of the equipment power cable,
an electrical connector electrically coupled to the equipment power cable, and
a coupling mechanism; and
a DC unit that comprises
a DC power cable that comprises a fixed end and a DC plug end,
a DC electrical connector electrically coupled to the DC power cable, and
a coupling mechanism that couples to the coupling mechanism of the cable holder unit,
wherein, in a coupled orientation of the cable holder unit and the DC unit, the electrical connector of the cable holder unit connects to the electrical connector of the DC unit to electrically connect the DC plug end and the equipment plug end of the equipment power cable.

2. The system of claim 1 wherein an inner surface of the cable reel defines the plug holder.

3. The system of claim 2 wherein the inner surface of the cable reel comprises an elastomer.

4. The system of claim 1 wherein the coupling mechanism of the cable holder unit and the coupling mechanism of the DC unit comprise at least one rail.

5. The system of claim 1 wherein the DC plug end comprises an assembly that comprises multiple DC plugs.

6. The system of claim 1 wherein the DC unit comprises a recess for storage of the DC plug end.

7. The system of claim 1 wherein the electrical connector of the cable holder unit comprises a prong and wherein the electrical connector of the DC unit comprises a socket.

8. The system of claim 1 wherein the coupling mechanism and the electrical connector of the cable holder unit are positioned on an edge of the cable holder unit.

9. The system of claim 8 wherein the coupling mechanism and the electrical connector of the DC unit are positioned on an edge of the DC unit and wherein, in the coupled orientation of the cable holder unit and the DC unit, the cable holder unit and the DC unit are joined along their edges.

10. A system comprising:
a cable holder unit that comprises
an equipment power cable that comprises a fixed end and an equipment plug end,
a cable reel for storage of the equipment power cable,
a plug holder to secure the equipment plug end of the equipment power cable,
an electrical connector electrically coupled to the equipment power cable, and
a coupling mechanism; and
an AC unit that comprises
an AC power plug,
an AC electrical connector electrically coupled to the AC power plug, and
a coupling mechanism that couples to the coupling mechanism of the cable holder unit,
wherein, in a coupled orientation of the cable holder unit and the AC unit, the electrical connector of the cable holder unit connects to the electrical connector of the AC unit to electrically connect the AC power plug and the equipment plug end of the equipment power cable.

11. The system of claim 10 wherein an inner surface of the cable reel defines the plug holder.

12. The system of claim 11 wherein the inner surface of the cable reel comprises an elastomer.

13. The system of claim 10 wherein the coupling mechanism of the cable holder unit and the coupling mechanism of the AC unit comprise at least one rail.

14. The system of claim 10 wherein the AC power plug comprises an assembly that comprises multiple AC power plugs.

15. The system of claim 10 wherein the AC unit comprises a planar surface and wherein the AC power plug comprises retractable prongs that, in an unretracted orientation, extend outwardly from the planar surface.

16. The system of claim 10 wherein the electrical connector of the cable holder unit comprises a prong and wherein the electrical connector of the AC unit comprises a socket.

17. The system of claim 10 wherein the coupling mechanism and the electrical connector of the cable holder unit are positioned on an edge of the cable holder unit.

18. The system of claim 17 wherein the coupling mechanism and the electrical connector of the AC unit are positioned on an edge of the AC unit and wherein, in the coupled orientation of the cable holder unit and the AC unit, the cable holder unit and the AC unit are joined along their edges.

19. A cable holder unit comprising:
an equipment power cable that comprises a fixed end and an equipment plug end;
a cable reel for storage of the equipment power cable;
a plug holder to secure the equipment plug end of the equipment power cable wherein an inner surface of the cable reel defines the plug holder;
an electrical connector positioned on an edge of the cable holder unit wherein the electrical connector is electrically coupled to the equipment power cable; and
a coupling mechanism positioned on the edge of the cable holder unit.

20. The cable holder unit of claim 19 further comprising at least one member selected from a group consisting of:
a DC unit that comprises a first coupling mechanism that couples to the coupling mechanism of the cable holder unit and a second coupling mechanism; and
an AC unit that comprises a coupling mechanism that couples to the coupling mechanism of the cable holder unit or that couples to the second coupling mechanism of the DC unit.
